(19) United States
(12) Patent Application Publication
(10) Pub. No.: US 2018/0337961 A1
(43) Pub. Date: Nov. 22, 2018

(54) Synchronization of UE Capability and Registration Status for SIP-Based Application Services

(71) Applicant: MEDIATEK INC., Hsinchu (TW)

(72) Inventor: Zong-Syun Lin, Kaohsiung City (TW)

(21) Appl. No.: 15/597,462

(22) Filed: May 17, 2017

(51) Int. Cl. H04L 29/06; H04L 12/58; H04W 8/22; H04W 60/04; H04W 76/02; H04L 29/08; H04W 56/00; H04W 76/06

(52) U.S. Cl. CPC H04L 65/1016; H04L 65/1006; H04L 51/043; H04W 8/22; H04L 65/1073; H04W 76/028; H04L 67/16; H04W 56/002; H04W 76/062; H04W 60/04

(57) ABSTRACT

A solution for synchronizing capability and registration status between a user equipment (UE) and a network application server is provided. After a UE registers with an IMS/RCS server for SIP-based application services, the UE capability and registration status is synchronized between the UE and the network. Later, the UE capability may change and the UE will try to send a SIP message to the network with an updated UE capability. However, error may occur due to UE out of service or network error, which requires the UE to re-sync with the network. Upon detecting a re-sync condition, the UE will then trigger re-sending the SIP message to the network or releasing the PDN connection such that the updated UE capability and registration status will be synchronized with the network.

### TECHNICAL FIELD

The disclosed embodiments relate generally to wireless communication, and, more particularly, to method of synchronization of UE capability and registration status when UE fails to notify network capability change.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards.

As set forth in the 3GPP, IP Multimedia Subsystem (IMS) is a core network that provides IP multimedia services to user equipments (UEs) over an Internet Protocol (IP) network. Historically, mobile phones have provided voice call services over a circuit-switched (CS) network, rather than strictly over an IP packet-switched (PS) network. Alternative methods of delivering voice or other multimedia services over IP have become available on smartphones (e.g. VoIP or Skype), but they have not become standardized across the industry. IMS is an architectural framework to provide such standardization. IMS is able to communicate with UEs through different types of access network, such as a wireless local area network (WLAN), an Ethernet network, a packet data network (PDN), or another type of access network. IMS is a new way to dial PS call on LTE (Voice over IP or Voice over LTE) instead of fallback to 2G/3G legacy CS call.

Rich Communication Services (RCS) is a communication protocol between mobile-telephone carriers and between phone and carrier, aiming at replacing short message service (SMS) messages with a text-message system that is more rich provide phonebook polling (for service discovery), and transmit in-call multimedia. RCS combines different services defined by 3GPP and Open Mobile Alliance (OMA) with an enhanced phonebook. Another phone's capabilities and presence information can be discovered and displayed by a mobile phone. RCS reuses 3GPP specified IMS system as the underlying service platform taking care of issues such as authentication, authorization, registration, charging and routing.

Both IMS and RCS contain several a plication services such as voice call (VoLTE), SMS, instant message (IM), discovery presence (DP), etc. over the IP network. UE will send SIP REGISTER to the network to inform UE's capability. When UE cap change for an IMS registered UE, UE will send a new SIP REGISTER message the latest capability to the network. If the SIP REGISTER sent failed UE will start a timer to resend the SIP message. During the retransmission, me registration status between UE and the network is un-sync. As a result, the network may use wrong way to notify UE for acquiring service. In one example, the service attempt may fail. In another example, the service attempt may succeed if the network retries other UE supported way, but the performance is affected.

A solution is sought.

### SUMMARY

A solution for synchronizing capability and registration status between a user equipment (UE) and a network application server is provided. After a UE registers with an IMS/RCS server for SIP-based application services, the UE capability and registration status is synchronized between the UE and the network. Later, the UE capability may change and the UE will try to send a SIP message to the network with an updated UE capability. However, error may occur due to UE out of service or network error, which requires the UE to re-sync with the network. Upon detecting a re-sync condition, the UE will then trigger re-sending the SIP message to the network or releasing the PDN connection such that the updated UE capability and registration status will be synchronized with the network.

In one embodiment, a user equipment (UE) establishes a packet data network (PDN) connection for transmitting and receiving IP layer data in a mobile communication network. The UE registers with the network for a list of session initiation protocol-based (SIP-based) services. The UE detects a UE capability change of the list of SIP-based services and notifying the network on the UE capability change. The UE transmits a SIP message to re-sync with the network upon detecting a re-sync condition of UE capability between the UE and the network. In one example, the list of SIP-based services belongs to IP Multimedia Subsystem (IMS) application service. In another example, the list of SIP-based services belongs to Rich Communication Service (RCS) application service. In one scenario, the re-sync condition is detected when the UE is out of service and then returns to service when the UE capability changes. The UE sends the SIP message to the network immediately upon the UE returns to service to PUBLISH an updated service list. In another scenario, the re-sync condition is detected when the UE has not successfully updated its registration status after a predefined time threshold. The UE sends the SIP message to the network to release the PDN connection and to reestablish a new PDN connection to REGISTER with the updated service list.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network supporting session initiation protocol (SIP) based application services with UE capability synchronization in accordance with one novel aspect.

FIG. 2 illustrates simplified block diagrams of a user equipment (UE) and a base station (BS) and an application server in accordance with embodiments of the current invention.

FIG. 3 illustrates one embodiment of UE capability change and un-sync status due to UE out of service and re-sync with the network in accordance with embodiments of the current invention.

FIG. 4 illustrates one embodiment of UE capability change and un-sync status due to network condition and re-sync with the network in accordance with embodiments of the current invention.

FIG. 5 is a flow chart of a method of synchronizing UE capability with a network application server for SIP-based application services in accordance with one novel aspect.

### DETAILED DESCRIPTION

Reference will now be made in detail to some embodiments of the invention, examples of which are illustrated in the accompanying drawings.

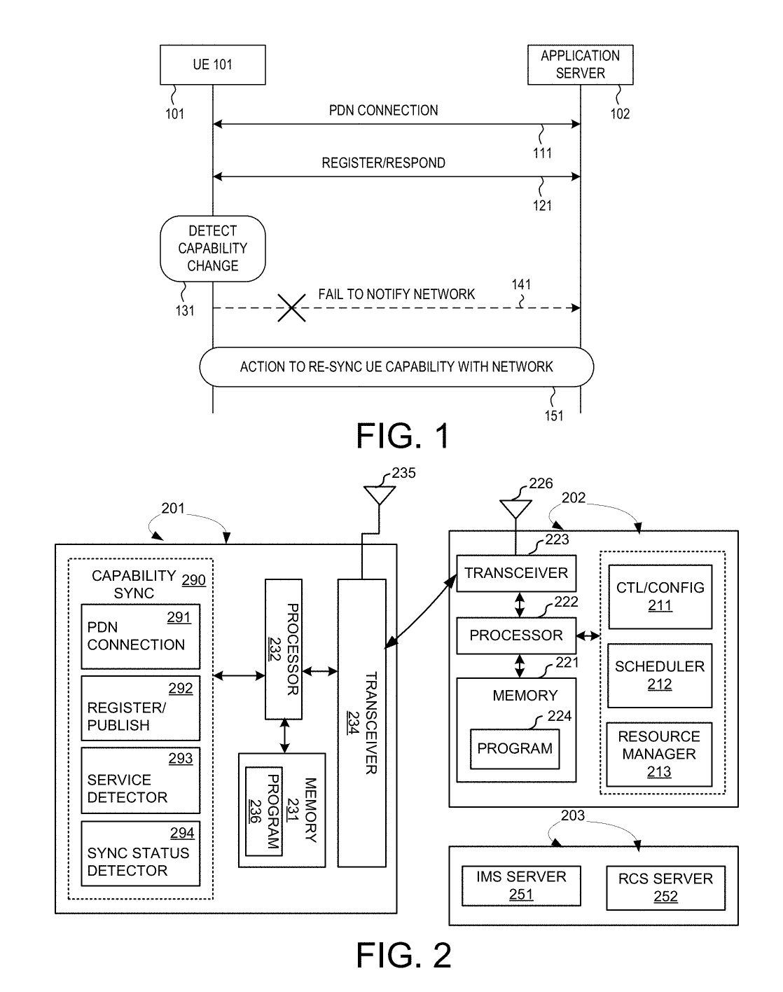

FIG. 1 illustrates a mobile communication network supporting session initiation protocol (SIP) based application services with UE capability synchronization in accordance with one novel aspect. The mobile communication network supports different services/connections through different radio access technologies (RATs) or different service domains. UE 101 may be equipped with a single radio frequency (RF) module/transceiver or multiple RF modules/transceivers for services via different RATs/service domains. UE 101 may be a smart phone, a wearable device, an Internet of Things (IoT) device, a tablet, etc. The services may be IP services. Here, a service may include voice services such as normal call, emergency call, supplementary service and data services includes short message service (SMS) and other data services (e.g., web browsing and file transfer on the Internet). For voice service, a service domain may include circuit-switched (CS) service domain, packet-switched (PS) service domain, and IMS service domain. For data service, a service domain may include different RATs of 2G/3G/4G and Wi-Fi technology.

As set forth in the 3GPP, IP Multimedia Subsystem (IMS) is a core network that provides IP multimedia services to UEs over an Internet Protocol (IP) network. IMS application service includes telephony, fax, email, Internet access, voice over IP, instant message, and videoconference. Similarly, Rich Communication Service (RCS) reuses 3GPP specified IMS system as the underlying service platform to provide enhanced messaging services. RCS works with text, images, video, group text messages, and location sharing. RCS also provides an enhanced phone book with service discovery.

Both IMS and RCS contain several application services such as voice call, SMS, IM, DP, etc. over the IP network. UE will send SIP REGISTER to the network to inform UE's capability. When UE capability change for an IMS/RCS registered UE, UE will send a new SIP REGISTER message with the latest capability to the network. If the SIP REGISTER sent failed, UE will start a timer to resend the SIP message. During the retransmission, the registration status between UE and the network is un-sync. As a result, the network may use wrong way to notify UE for acquiring service. In one example, the service attempt may fail. In another example, the service attempt may succeed if the network retries other UE supported way, but the performance is affected.

In accordance with one novel aspect, a solution of synchronizing with UE capability and registration status between the UE and the network application server is provided. As depicted in FIG. 1, in step 111, UE 101 establishes a packet data network (PDN) connection with the network IMS/RCS server 102. The PDN connection setup involves establish an EPS radio bearer with a target PDN through its serving base station. In step 121, UE 101 sends a SIP registration message to the IMS/RCS server 102. The SIP registration message notifies which IMS/RCS services UE 101 supports and intends to use. In response, the IMS/RCS server 102 sends an OK message back to UE 101. As a result, the IMS/RCS server and the UE are sync with the UE capability with respect to the IMS/RCS services. In step 131, UE 101 detects that the UE capability changes. There are different scenarios when the UE capability changes. In a first scenario, a user disables certain functionality on the UE that is previously registered with the network. In a second scenario, the UE moves into a new network supporting different capabilities. In step 141, UE 101 tries to notify the IMS/RCS server 102 about such capability change. However, the notification fails to reach the network, or the network is too busy to process the notification. In step 151, UE 101 detects that a re-sync condition of UE capability between the UE and the network has satisfied due to a recoverable or an unrecoverable error. UE 101 then triggers re-sending SIP message to the network or releasing the PDN connection such that the updated UE capability and registration status will be synchronized. If the error is recoverable due to out of service, then the UE can re-send SIP message to re-sync UE capability and registration status after recovery. On the other hand, if the error is unrecoverable, then the UE can release the PDN connection to force to reset UE capability and registration status.

FIG. 2 illustrates simplified block diagrams of a user equipment UE 201 and a base station 202 and a network server 203 in accordance with embodiments of the current invention. BS 202 may have an antenna 226, which may transmit and receive radio signals. RF transceiver module 223, coupled with the antenna, may receive RF signals from antenna 226, convert them to baseband signals and send them to processor 222. RF transceiver 223 may also convert received baseband signals from processor 222, convert them to RF signals, and send out to antenna 226. Processor 222 may process the received baseband signals and invoke different functional modules to perform features in BS/AP 202. Memory 221 may store program instructions and data 224 to control the operations of BS202. BS202 may also include a set of control circuits, such as a control and configuration circuit 211, a scheduler 212, and a resource manager 213 that may carry out functional tasks and features in the network.

Similarly, UE 201 has an antenna 235, which may transmit and receive radio signals. RF transceiver module 234, coupled with the antenna, may receive RF signals from antenna 235, convert them to baseband signals and send them to processor 232. RF transceiver 234 may also convert received baseband signals from processor 232, convert them to RF signals, and send out to antenna 235. Processor 232 may process the received baseband signals and invoke different functional modules to perform features in the UE 201. Memory 231 may store program instructions and data 236 to control the operations of the UE 201. At the network side, application server 203 maybe an IMS server or an RCS server that provides various IMS/RCS application services to UE 201.

UE 201 may also include a set of control circuits that may carry out functional tasks of the present invention. A UE capability synchronization module 290 may detect UE capability change and the un-sync status with the network and triggering corresponding actions accordingly to re-sync with the network. Capability synchronization module 290 may further comprise a PDN connection circuit 291 that may establish PDN connection for data/voice services over the IP network, a registration circuit 292 that may register and/or publish the UE capability, a service detector 293 that may detect UE capability change, and a sync status detector 294 that may detect the un-sync status of UE capability and such un-sync is caused by a recoverable or an unrecoverable error. If the error is recoverable due to out of service, then the UE can re-send SIP message to re-sync capability and registration status after recovery. If the error is unrecoverable, then the UE can release the PDN connection to force to reset capability and registration status.

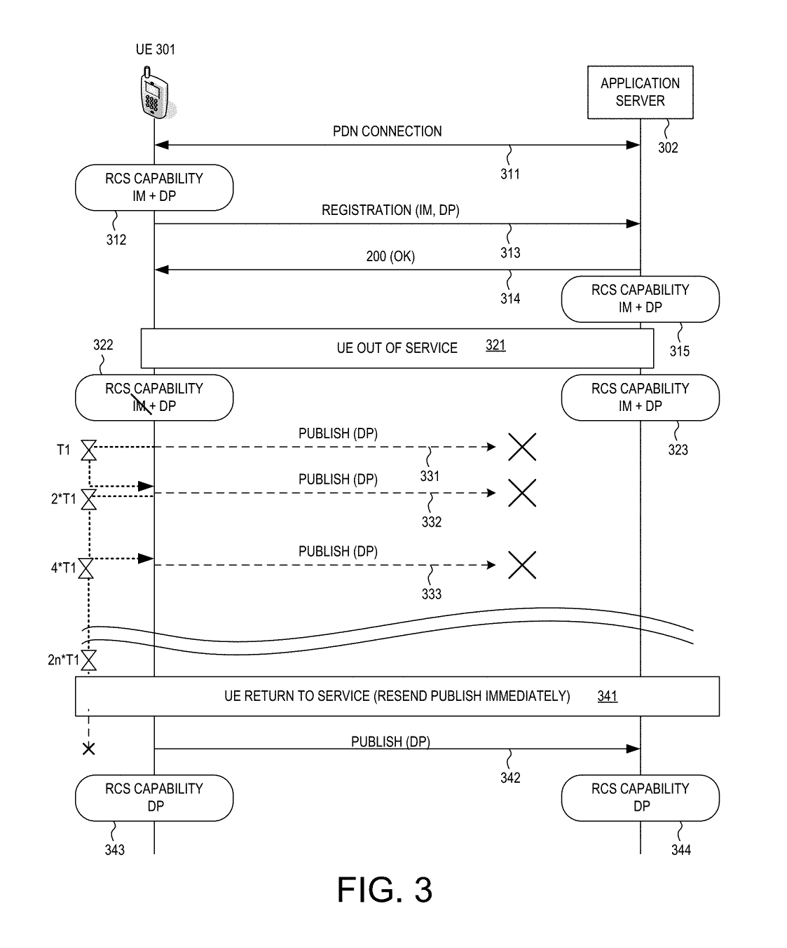

FIG. 3 illustrates one embodiment of UE capability change and un-sync status due to UE out of service and re-sync with the network in accordance with embodiments of the current invention. In step 311, UE 301 establishes a PDN connection with the network and is connected to an application server 302, e.g., an RCS server. In step 312, UE 301 determines its RCS capability, e.g., instant message and discovery presence (IM+DP). In step 313, UE 301 sends a SIP registration message to RCS server 302. In step 314, the RCS server responds with OK. In step 315, the RCS capability (IM+DP) is synchronized between the UE and the RCS server. In step 321, UE 301 is out of service. In step 322, UE 301 disables its IM capability. However, the RCS server 302 is still registered with IM+DP capability for UE 301 (step 323). The RCS registration status between the UE and the RCS server is unsynchronized. In step 331, UE 301 sends a SIP PUBLISH message to the RCS server 302. This message notifies the network that the UE is only registered with DP service, no IM service anymore. However, because the UE is still out of service, the SIP PUBLISH message cannot be properly delivered to the RCS server. When the SIP message failed, the UE starts a timer to resend the SIP message in step 332. The retransmission timer will be T1, 2*T1, 4*T1, . . . 2n*T1 seconds for subsequent attempts. However, the retransmission SIP message continues to fail because the UE is still out of service. In step 341, UE 301 returns to service and UE 301 knows that the RCS registration status between the UE and the RCS server is still unsynchronized. As a result, a re-sync condition is satisfied, and UE 301 immediately sends another SIP PUBLISH message to the network in step 342. After successful delivery and process of the SIP message, the RCS capability (DP) between the UE and the network is synchronized.

In accordance with one advantageous aspect, upon detecting the re-sync condition, e.g., UE RCS capability change and UE returns to service from out of service, the UE immediately sends a new SIP PUBLISH message to the network such that the RCS capability and registration status between the UE and the network is synchronized right away to avoid potential error. Otherwise, when the UE returns to service, the network still thinks that the UE has IM capability and may send an instant message to the UE. As a result, the IM service attempt may fail. By immediately resending a new SIP PUBLISH message upon the UE returning to service regardless of the timer expiry status, the potential service error can be avoided to improve performance and user experience.

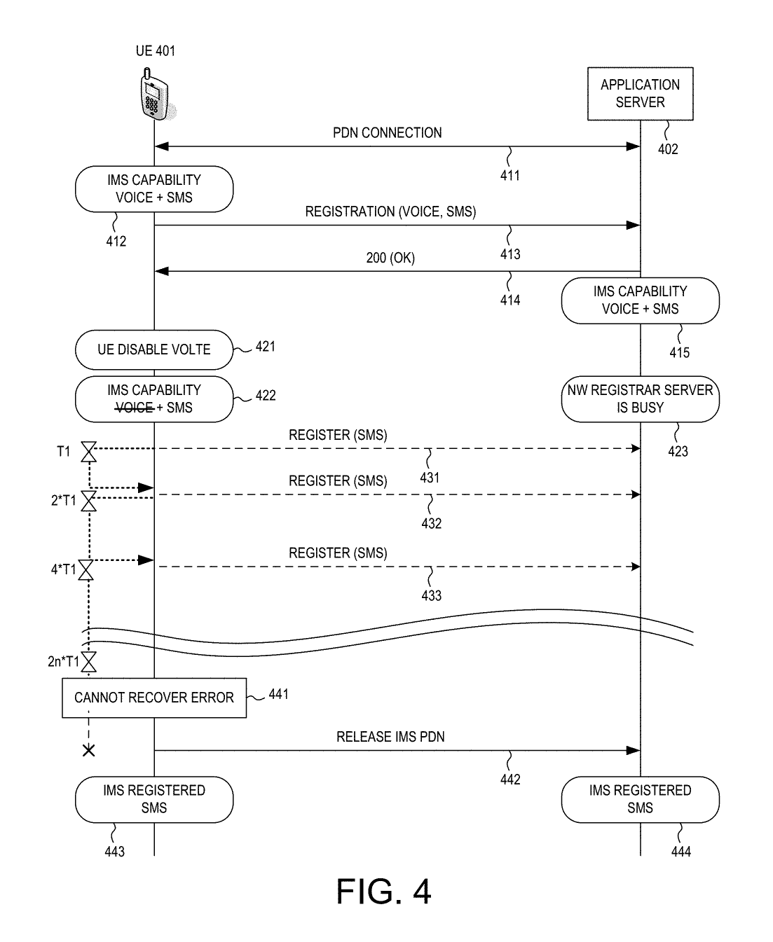

FIG. 4 illustrates one embodiment of UE capability change and un-sync status due to network condition and re-sync with the network in accordance with embodiments of the current invention. In step 411, UE 401 establishes a PDN connection with the network and is connected to an application server 302, e.g., an IMS server. In step 412, UE 401 determines its IMS capability, e.g., voice over IP (VoLTE) and short message service (VoLTE+SMS). In step 413, UE 401 sends a SIP registration message to IMS server 402. In step 414, the IMS server responds with OK. In step 415, the IMS capability (VoLTE+SMS) is synchronized between the UE and the IMS server. In step 421, a user of UE 401 disables the VoLTE service. In step 422, the IMS capability of UE 401 is updated to SMS only. However, the IMS server 402 is still registered with (VoLTE+SMS) capability for UE 401. The IMS registration status between the UE and the IMS server is unsynchronized. Furthermore, the network registrar server becomes busy (step 423). In step 431, UE 401 sends a SIP REGISTER message to the IMS server 402. This message notifies the network that the UE is only registered with SMS service, no VoLTE service anymore. However, because the network registrar server is busy, the SIP REGISTER message cannot be properly processed by the IMS server. When the SIP message failed, the UE starts a timer to resend the SIP message in step 432. The retransmission timer will be T1, 2*T1, 4*T1, . . . 2n*T1 seconds for subsequent attempts. However, the retransmission SIP message continues to fail because the network registrar server is still busy. In step 441, UE knows that the IMS registration status between the UE and the RCS server is still unsynchronized due to network error and such error cannot be recovered by the UE. As a result, a re-sync condition is satisfied, and UE 401 releases the PDN connection in step 442. By releasing and reestablish the PDN connection, it forces the network to reset all of the IMS registration and capability. After successful PDN establishment and SIP registration, in steps 443 and 444, the IMS capability (SMS) between the UE and the network is synchronized.

In accordance with one advantageous aspect, upon detecting the re-sync condition, e.g., UE IMS capability change and network error for failing to register the updated capability after a predefined time threshold, the UE releases the PDN connection such that the IMS capability and registration status between the UE and the network is forced to be reset and then re-synchronized to avoid potential error. Otherwise, when another user dials an MT call, the network still thinks that the UE has VoLTE capability and may send an INVITE message to the UE for the MT VoLTE call. As a result, the VoLTE service attempt may fail. By forcing to release the PDN connection upon detecting the unrecoverable network error for registration, the potential service error can be avoided to improve performance and user experience.

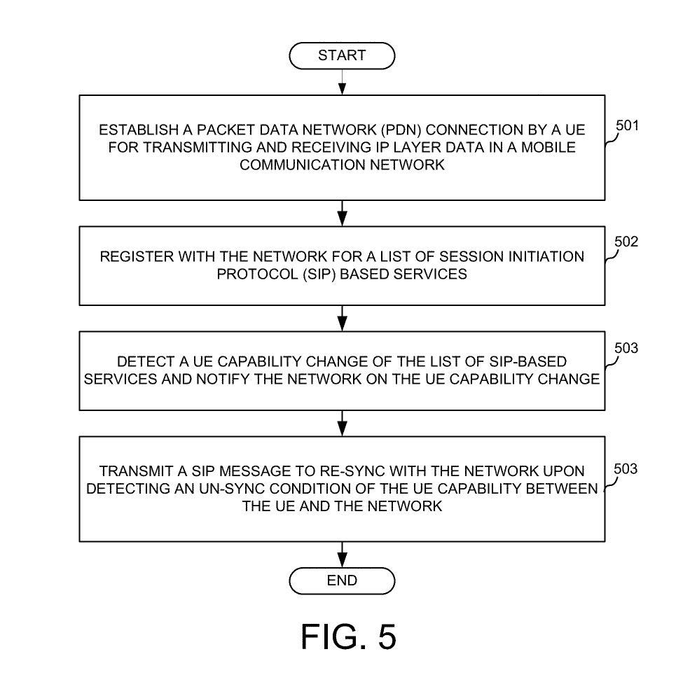

FIG. 5 is a flow chart of a method of synchronizing UE capability with a network application server for SIP-based application services in accordance with one novel aspect. In step 501, a user equipment (UE) establishes a packet data network (PDN) connection for transmitting and receiving IP layer data in a mobile communication network. In step 502, the UE registers with the network for a list of session initiation protocol-based (SIP-based) services. In step 503, the UE detects a UE capability change of the list of SIP-based services and notifying the network on the UE capability change. In step 504, the UE transmits a SIP message to re-sync with the network upon detecting re-sync condition of UE capability between the UE and the network. In one example, the list of SIP-based services belongs to IP Multimedia Subsystem (IMS) application service. In another example, the list of SIP-based services belongs to Rich Communication Service (RCS) application service. In one scenario, the re-sync condition is detected when the UE is out of service and then returns to service when the UE capability changes. The UE sends the SIP message to the network immediately upon the UE returns to service to PUBLISH an updated service list. In another scenario, the re-sync condition is detected when the UE has not successfully updated its registration status after a predefined time threshold. The UE sends the SIP message to the network to release the PDN connection and to reestablish a new PDN connection to REGISTER with the updated service list.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
establishing a packet data network (PDN) connection by a user equipment (UE) for transmitting and receiving IP layer data in a mobile communication network;
registering with the network for a list of session initiation protocol-based (SIP-based) services;
detecting a UE capability change of the list of SIP-based services and notifying the network on the UE capability change; and
transmitting a SIP message to re-sync with the network upon detecting a re-sync condition of the UE capability between the UE and the network.

2. The method of claim 1, wherein the list of SIP-based services belongs to IP Multimedia Subsystem (IMS) application service.

3. The method of claim 2, wherein the IMS application service comprises telephony, fax, email, Internet access, voice over IP, instant message, and videoconference.

4. The method of claim 1, wherein the list of SIP-based services belongs to Rich Communication Service (RCS) application service.

5. The method of claim 4, wherein the RCS application service comprises instant message (IM) and discovery presence (DP).

6. The method of claim 1, wherein the re-sync condition is detected when the UE is out of service and then returns to service when the UE capability changes.

7. The method of claim 6, wherein the UE sends the SIP message to the network immediately upon the UE returns to service to PUBLISH an updated service list.

8. The method of claim 1, wherein the re-sync condition is detected when the UE has not successfully updated its registration status with an updated service list after a predefined time threshold.

9. The method of claim 8, wherein the UE sends the SIP message to the network to release the PDN connection and reestablish a new PDN connection to REGISTER with the updated service list.

10. The method of claim 1, wherein the UE capability change is detected when the UE disables a service functionality or when the UE moves to a new network with different capabilities.

11. A User Equipment (UE), comprising:
a packet data network (PDN) connection handler that establishes a PDN connection for transmitting and receiving IP layer data in a mobile communication network;
an application layer service handler that registers with the network for a list of session initiation protocol-based (SIP-based) services;
a service detector that detects a UE capability change of the list of SIP-based services and notifying the network on the UE capability change; and
a transmitter that transmits a SIP message to re-sync with the network upon detecting re-sync condition of the UE capability between the UE and the network.

12. The UE of claim 11, wherein the list of SIP-based services belongs to IP Multimedia Subsystem (IMS) application service.

13. The UE of claim 12, wherein the IMS application service comprises telephony, fax, email, Internet access, voice over IP, instant message, and videoconference.

14. The UE of claim 11, wherein the list of SIP-based services belongs to Rich Communication Service (RCS) application service.

15. The UE of claim 14, wherein the RCS application service comprises instant message (IM) and discovery presence (DP).

16. The UE of claim 11, wherein the re-sync condition is detected when the UE is out of service and then returns to service when the UE capability changes.

17. The UE of claim 16, wherein the UE sends the SIP message to the network immediately upon the UE returns to service to PUBLISH an updated service list.

18. The UE of claim 11, wherein the re-sync condition is detected when the UE has not successfully updated its registration status with an updated service list after a predefined time threshold.

19. The UE of claim 18, wherein the UE sends the SIP message to the network to release the PDN connection and reestablish a new PDN connection to REGISTER with the updated service list.

20. The UE of claim 11, wherein the UE capability change is detected when the UE disables a service functionality or when the UE moves to a new network with different capabilities.
